(19) United States
(12) Patent Application Publication
(10) Pub. No.: US 2015/0039500 A1
(43) Pub. Date: Feb. 5, 2015

(54) PROCESS FOR INVOICE AGENT COUPLING

(71) Applicant: MASCO CORPORATION, Taylor, MI (US)

(72) Inventors: Thomas Doyle Byrne, Northville, MI (US); Steven James Horler, Ann Arbor, MI (US); Scott A. Halpert, Ann Arbor, MI (US)

(73) Assignee: MASCO CORPORATION, Taylor, MI (US)

(21) Appl. No.: 13/958,812

(22) Filed: Aug. 5, 2013

(51) Int. Cl. G06Q 20/10; G06Q 20/40

(52) U.S. Cl. CPC G06Q 20/102; G06Q 20/40
USPC 705/40

(57) ABSTRACT

A method for invoice agent coupling includes, among other things, receiving a service invoice generated by a primary service provider and receiving an authorization of payment of the service invoice. Additional steps include receiving a request for early payment authorization, and transmitting a services payment to the primary service provider.

### BACKGROUND

This disclosure relates to supply chain financing, and more particularly to invoice agent coupling.

A buyer and seller of goods typically coordinate a delivery of goods by utilizing the services of a freight carrier. In some cases, the buyer relies on a third-party freight audit and payment (FAP) service provider for auditing freight charges and coordinating payments to the freight carrier. The buyer may also rely on a third party supply chain financing (SCF) service provider to confirm that goods or services provided by a supplier are accurately charged to the buyer, and may also rely on the SCF service to provide payments to the supplier. In some cases, the supplier may request early payment in the form of a short-term financing arrangement coordinated by the third party SCF service provider.

Generally, the SCF service provider requires an invoice with detailed payment information prior to coordinating the short-term financing arrangement. However, the buyer may not directly receive a freight invoice including detailed payment information from the freight carrier. Instead, the freight carrier may provide the freight invoice to the FAP service so that the buyer does not have to coordinate this activity. Generally, the FAP service presents the freight invoice to the buyer for approval, and thereafter the FAP service coordinates payment to the freight carrier. Also, the SCF and FAP services are not in data communication with each other. Thus, for the buyer to efficiently rely on both the third party FAP and SCF services, and for freight carrier to enter into a short-term financing arrangement coordinated by the SCF service provider, a process for coupling the third-party FAP and SCF services together for the FAP service to provide the detailed payment information directly to the SCF service is needed.

### SUMMARY

In one exemplary embodiment, a method for invoice agent coupling includes the steps of receiving a service invoice generated by a primary service provider, receiving an authorization of payment of the service invoice, receiving a request for early payment authorization, and transmitting a services payment to the primary service provider.

In a further embodiment of the above, the transmitting step is performed prior to a predetermined maturity date.

In a further embodiment of any of the above, the request for early payment authorization is generated by a freight carrier.

In a further embodiment of any of the above, the service invoice is generated by a business payment agent, with the business payment agent being authorized to transmit the service invoice on behalf of a client of the primary service provider.

In another exemplary embodiment, a method for invoice agent coupling includes the steps of receiving a service invoice generated by a primary service provider, authorizing payment of the service invoice, transmitting the service invoice to a supply chain financing service provider, and transmitting a services payment to the primary service provider.

In a further embodiment of any of the above, the method includes the step of negotiating a payment agreement between the primary service provider and a client of the primary service provider prior to receiving the service invoice generated by the primary service provider.

In a further embodiment of any of the above, the method includes the step of accessing a supply chain financing portal provided by the supply chain financing service provider prior to of receiving the service invoice generated by the primary service provider.

In a further embodiment of any of the above, the method includes the step of processing a request for early payment authorization in response to transmitting the service invoice to the supply chain financing service provider. Further, the step of transmitting a services payment to the primary service provider is performed prior to a predetermined maturity date.

In a further embodiment of any of the above, the step of processing the request for early payment authorization is performed by the primary service provider.

In a further embodiment of any of the above, the method includes the step of negotiating a financing agreement between a financial institution and the primary service provider. Further, the services payment is provided by the financial institution.

In a further embodiment of any of the above, the financing agreement is guaranteed by a client of the primary service provider.

In a further embodiment of any of the above, the step of auditing the service invoice additionally includes receiving a shipping record, and comparing the shipping record and the service invoice.

In a further embodiment of any of the above, the method further includes the step of confirming receipt of an article associated with the shipping record.

These and other features disclosed herein can be best understood from the following specification and drawings, the following of which is a brief description.

### BRIEF DESCRIPTION OF THE DRAWINGS

FIG. 1 is a schematic view of a prior art invoice system.

FIG. 2A is a flow chart of an auditing process for a coupled invoice system.

FIG. 2B is a flow chart of a supply chain financing process for the coupled invoice system of FIG. 2A.

FIG. 2C is a flow chart of the supply chain financing process of FIG. 2B.

### DETAILED DESCRIPTION

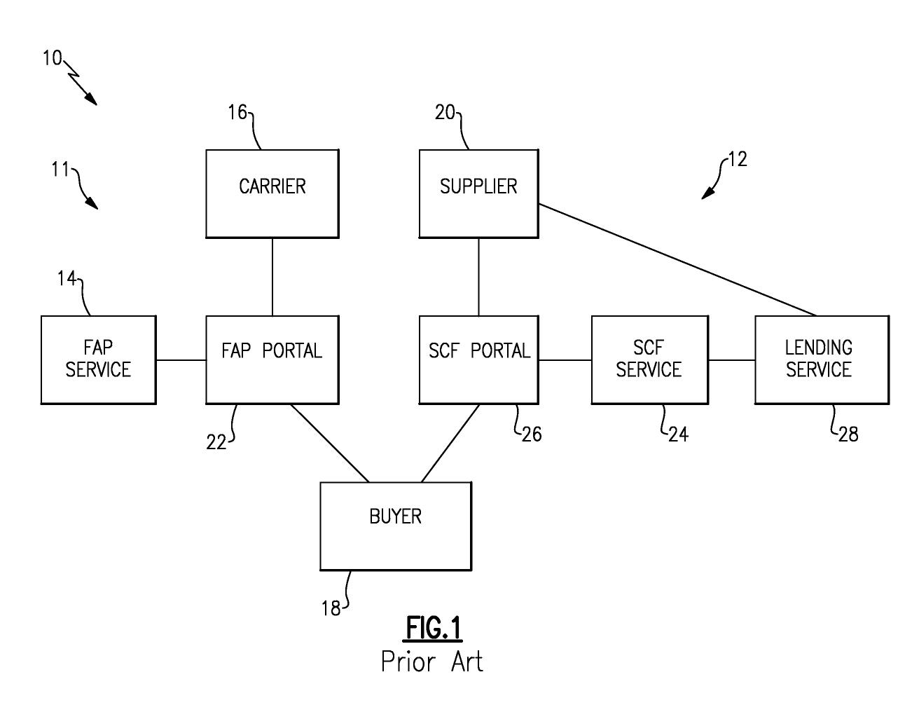

FIG. 1 illustrates a schematic view of a prior art uncoupled invoice system 10. The uncoupled invoice system 10 includes a standalone Freight Audit and Payment (FAP) system 11 and a standalone Supply Chain Financing (SCF) system 12. The FAP system 11 includes an FAP service 14 provided by a third party FAP service provider. Generally, the FAP service is configured to audit the accuracy of a freight invoice issued by a freight carrier 16 to a freight client or buyer 18 for goods purchased from a supplier 20. The buyer 18 may transmit a shipment invoice to the FAP service provider including the weight of the shipment. In another example, the supplier 20 transmits the shipment invoice to the FAP service provider. The FAP service 14 may also be configured to provide a payment to the freight carrier 16 in response to approval of the freight invoice by the buyer 18.

The freight carrier 16 and the buyer 18 may each access the FAP service 14 through a FAP portal 22 provided by the FAP service provider, the freight carrier 16 or the buyer 18. Generally, the freight carrier 16 submits a freight invoice electronically to the FAP service provider via the FAP portal 22. However, the freight carrier 16 may also submit a freight invoice in paper form, to be later imported by the FAP service provider. The freight invoice includes detailed payment information. The detailed payment information generally includes a weight of the goods transported by the freight carrier 16, a shipping route of the goods and a pre-negotiated shipping rate corresponding to the shipping route of the goods. The detailed payment information may also include payment terms. For example, the payment terms may require the buyer 18 to pay the freight carrier 16 within fifteen, thirty or sixty days of receipt of the freight invoice.

The FAP portal 22 includes a dashboard (not shown) configured to provide a convenient environment for the buyer 18 to review a summary of each freight invoice without reviewing the detailed payment information or other information identified in each freight invoice. Generally, the summary of each freight invoice includes the pre-defined shipping rate and the weight of the goods transported by the freight carrier 16. Thus, the buyer 18 is not burdened by receiving and posting the freight invoices to the FAP portal 22, nor does the buyer 18 have to provide payment terms and shipping rates for each freight invoice to the FAP service provider prior to the FAP service provider conducting an audit of the freight invoice.

The SCF system 12 includes a SCF service 24 provided by a third party SCF service provider. Generally, the SCF service 24 is configured to audit the accuracy of an invoice of goods or services provided by the supplier 20 and provide a payment to the supplier 20 after the buyer 18 approves the invoice of goods or services. The buyer 18 and the supplier 20 may each access the SCF service 24 through an SCF portal 26 provided by the SCF service provider, the buyer 18 or the supplier 20. Generally, the buyer 18 provides an approved invoice of goods to the SCF service 24, and the supplier 20 may review the approved invoice.

The supplier 20 may request an early payment authorization by accessing the SCF portal 26. That is, the supplier 20 may request payment prior to a predetermined maturity date of the approved invoice. It should be understood that the predetermined maturity date is defined as the date on which the buyer 18 is contractually obligated to repay the amount due to the supplier 20. The SCF service 24 is configured to access a short-term lending service 28 provided by a third party financial institution. The supplier 20 enters into a short-term financing arrangement whereby the supplier 20 receives payment from the financial institution, with the short-term loan being guaranteed by the buyer 18. The buyer 18 reimburses the financial institution once the approved invoice reaches the predetermined maturity date. However, the supplier 20 receives payment on the predetermined maturity date when the supplier 20 does not request an early payment authorization. This short-term financing arrangement increases the overall cash flow and financial health of the supplier 20 and may also permit the buyer 18 to negotiate more favorable payment terms with the supplier 20.

However, the FAP and SCF systems 11, 12 are not coupled together or in data communication with each other. Thus, the buyer 18 must upload approved freight invoices to the SCF portal 26, even though the FAP system 11 is specially configured to accept freight invoices from the freight carrier 16 and post a summary of the freight invoices to the buyer 18 for approval. Thus, the buyer 18 is burdened by receiving and sending the detailed payment information between the FAP and SCF systems 11, 12. Moreover, the freight carrier 16 does not have an efficient way of requesting an early payment authorization for freight invoices.

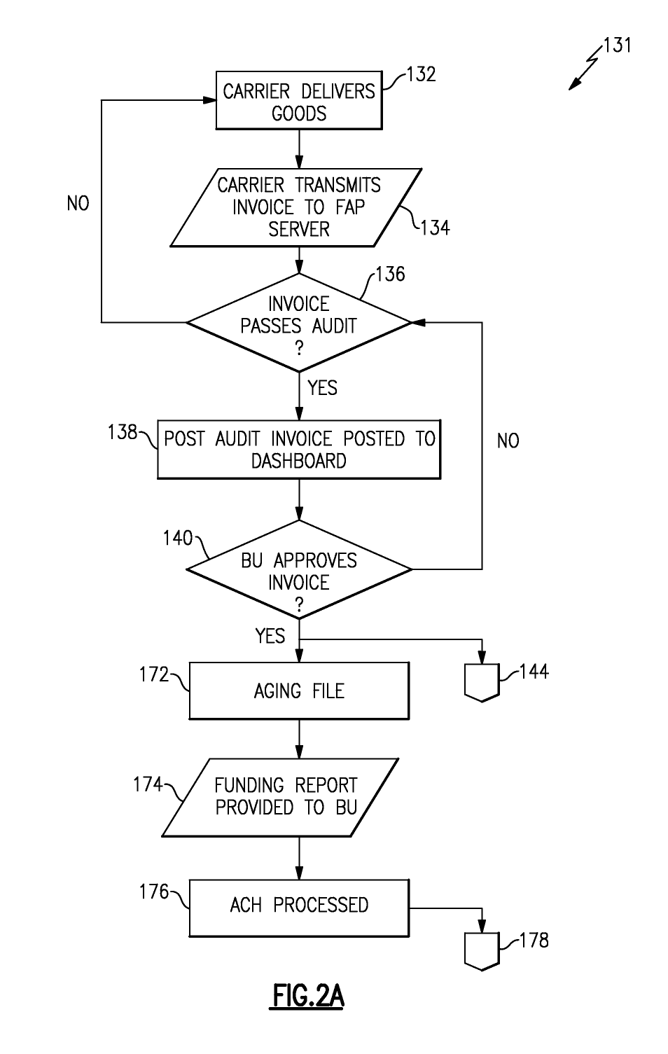

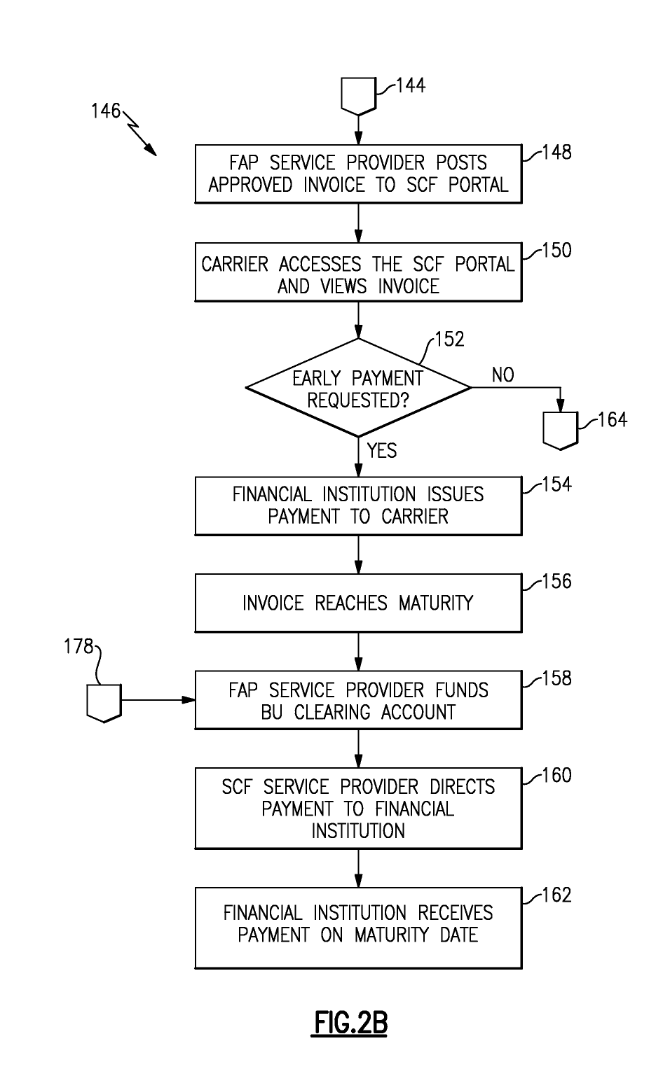

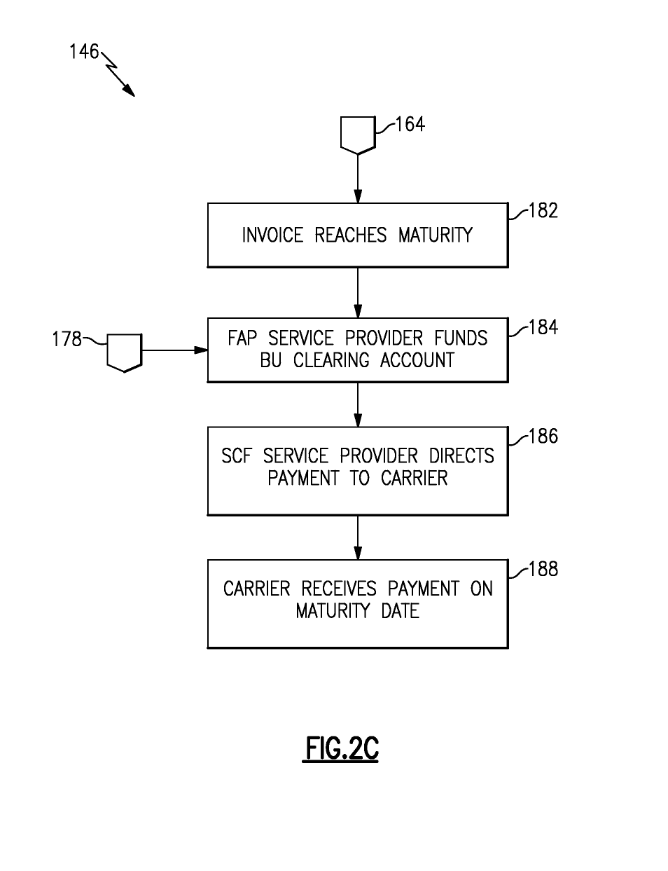

FIGS. 2A-2C illustrate a flow diagram for a coupled invoice system 130 according to one embodiment of the present disclosure. In this disclosure, like reference numerals designate like elements where appropriate and reference numerals with the addition of one-hundred or multiples thereof designate modified elements that are understood to incorporate the same features and benefits of the corresponding original elements. As shown in FIG. 2A, the coupled invoice system 130 includes a freight auditing process 131 executed by an FAP server 114 (shown in FIG. 1). Generally, a freight carrier 116 provides a shipment of goods, and incurs one or more freight expenses, as shown at step 132. The buyer 118 may engage an FAP service provider to provide freight auditing services. At step 134, the freight carrier 116 transmits a pre-audit invoice to the FAP server 114 through a FAP portal 122 (shown in FIG. 1). It should be appreciated that auditing process 131 may be adapted to audit invoices for any service provided by a primary service provider. In another embodiment, the auditing process 131 may audit invoices provided to a client for advertisements and promotions. It should be appreciated that primary services provider refers to a service offered to the buyer 118 other than invoice auditing and supply chain financing services.

At step 136, the FAP server 114 (shown in FIG. 1) conducts a pre-audit, by comparing each of the freight charges identified by the pre-audit invoice to a shipment invoice for the goods delivered by the freight carrier 116 to the buyer 118. The FAP service provider may also manually perform a portion of the step 136. The FAP service provider may compare the rate identified in the pre-audit invoice to one or more rate tables agreed to between the freight carrier 116 and the buyer 118. The rate tables may be stored on a FAP server executing the FAP service 114. In the event of any discrepancies, the FAP service provider notifies the freight carrier 116 to reissue a corrected pre-audit invoice at step 132. Accordingly, the buyer 118 may avoid an incurrence of one or more erroneous freight charges. After the pre-audit invoice passes the pre-audit at step 136, a post-audit invoice is generated and posted to the FAP portal 122 (shown in FIG. 1) at step 138. Thereafter, a business unit (BU) of the buyer 118 accesses a dashboard (not shown) provided by the FAP portal 122 (shown in FIG. 1) to review a summary of the post-audit invoice, shown at step 138.

The BU of the buyer 118 may approve or reject the post-audit invoice at step 140. In some instances, the post-audit invoice may be compared to one or more business rules of the buyer 118. In one example, the buyer 118 may object to the weight or shipping rate indicated on the freight invoice. In another example, the buyer 118 may object to one or more freight charges due to the untimely delivery of the goods to the buyer 118. In yet another example, the buyer 118 may object to the shipping route used by the freight carrier 116 to deliver the goods to the buyer 118. In yet another example, the buyer 118 may object to miscellaneous charges such as fuel or customs fees. If the BU of the buyer 118 rejects the post-audit invoice at step 140, the invoice is returned to the pre-audit at step 136, and the FAP service provider notifies the freight carrier 116 at step 132 to provide a corrected pre-audit invoice at step 134.

Once the post-audit invoice is approved by the buyer 118, an entry for the approved post-audit invoice is appended to an aging file at step 172. The aging file includes an entry for each post-audit invoices and the predetermined maturity date associated with each of the post-audit invoices. One or more aging rules may be applied to the post-audit invoice to identify when a payment to the freight carrier 116 is due. Generally, the freight carrier 116 is paid by the buyer 118 when the post-audit invoice reaches the predetermined maturity date defined by the payment terms. Thereafter, the post-audit invoice is released to a funding report generated at step 174 to identify each post-audit invoice eligible for payment according to the generated at aging file at step 172. At step 176, the BU of the buyer 118 approves the funding report and authorizes the FAP service provider to process payments through an Automated Clearing House (ACH).

Referring to FIG. 2B, the coupled invoice system 130 includes a supply chain finance (SCF) process 146. Generally, the SCF process 146 is executed by the SCF server 124 (shown in FIG. 1). The BU of the buyer 118 receives the post-audit invoice from the SCF service provider by way of the FAP portal 122 (shown in FIG. 1) and posts the information to the SCF portal 126 (shown in FIG. 1) at step 148. However, this requires the buyer 118 to present more detailed information to the SCF service provider than is required for the BU of the buyer 118 to approve the post-audit invoice for payment. In another example, the buyer 118 provides the FAP entity with business unit status. In this arrangement, the FAP service provider may post the post-audit invoice and other detailed payment information directly to the SCF portal 126, and the FAP service provider also has the legal authority to conduct business on behalf of the buyer 118, including all steps in the SCF process 146 otherwise performed by the BU of the buyer 118. In yet another example, the buyer 118 provides a business payment agent status to the FAP service provider by naming the FAP service provider as an additional party to an SCF contract binding the SCF service provider and the buyer 118. Accordingly, the FAP service provider is authorized to upload the post-audit invoice and other remittance advice information directly to the SCF portal 126 and authorize the SCF service provider to make a payment to the freight carrier 116 according to the SCF contract.

At step 150, the freight carrier 116 accesses the SCF portal 126 (shown in FIG. 1) and views the post-audit invoice. Thereafter, the freight carrier 116 may make a request for early payment authorization at step 152. Accordingly, the freight carrier 116 has the option of receiving payment for freight charges prior to a maturity date previously agreed to by the buyer 118 and the freight carrier 116. If the freight carrier 116 makes the request for early payment authorization, the SCF service provider coordinates a short-term financing arrangement between the freight carrier 116 and a third party financial institution or lender. In this arrangement, the buyer 118 may agree to guarantee a short-term loan made to the freight carrier 116 by the financial institution. Thus, the freight carrier 116 may leverage a credit rating of the buyer 118 to obtain more favorable financing terms for the short-term loan and may also increase the freight carriers 116 overall cash flow. The SCF server 124 (shown in FIG. 1) may generate a financing request and submit the financing request to a short-term lending service 128 provided by the financing institution. In another example, the SCF service provider manually coordinates the short-term financing arrangement.

Upon approval of the request for the early payment authorization, the lender issues a payment to the freight carrier 116 at step 154. Once the freight invoice reaches the maturity date at step 156 and the buyer 118 approves the FAP service provider to process a payment at step 176, the FAP service provider funds a buyer clearing account at step 158. In this arrangement, the buyer clearing account belongs to the buyer 118, but the FAP service provider administers the clearing account. Thereafter, the SCF service provider directs a payment to the financial institution at step 160. Finally, at step 162 the financial institution receives a payment on the maturity date of the invoice to reimburse the financial institution for the short-term loan made to the freight carrier 116.

Optionally, the freight carrier 116 may not submit a request for early payment authorization at step 152. Referring to FIG. 2C, the freight invoice reaches the maturity date at step 182. Thereafter, the SCF service provider funds the clearing account at step 184. The SCF service provider then directs payment to the freight carrier 116 at step 186. The freight carrier 116 receives payment on the maturity date of the freight invoice at step 188.

The coupled invoice system 130 provides several benefits over the prior art uncoupled invoice system 10. The FAP service provider is authorized to provide detailed payment information directly to the SCF service provider. Thus, the BU of the buyer 118 does not have to provide this detailed payment information each time a post-audit freight invoice is generated by the FAP service provider. Also, the freight carrier 116 may increase its overall cash flow by making a request for early payment authorization, prior to the freight invoice reaching the predetermined maturity date. The buyer 118 may also receive more favorable payment terms by agreeing to guarantee the short-term loan to the freight carrier 116. Additionally, the freight carrier 116 receives notice of any disputed charges in advance of payment of the invoice by the buyer 118, facilitating early issue resolution between the parties and allows the freight carrier 116 to request an early payment request earlier once the dispute is resolved.

Although the different embodiments have the specific components shown in the illustrations, embodiments of this disclosure are not limited to those particular combinations. It is possible to use some of the components or features from one of the embodiments in combination with features or components from another one of the embodiments. It should also be appreciated that the coupled invoice system may be executed by a single computer system or multiple computer systems located at one or more geographical locations. Additionally, other service providers may benefit from the teachings. The coupled invoice system may benefit other auditing processes and other types of invoices.

The preceding description is exemplary rather than limiting in nature. Variations and modifications to the disclosed embodiments may become apparent to those skilled in the art that do not necessarily depart from the essence of this disclosure. The scope of legal protection given to this disclosure can only be determined by studying the following claims.

What is claimed is:

1. A method for invoice agent coupling comprising the steps of:
a) receiving a service invoice generated by a primary service provider;
b) receiving an authorization of payment of said service invoice;
c) receiving a request for early payment authorization; and
d) transmitting a services payment to said primary service provider.

2. The method of claim 1, wherein said step d) is performed prior to a predetermined maturity date.

3. The method of claim 1, wherein said request for early payment authorization is generated by a freight carrier.

4. The method of claim 1, wherein said service invoice is generated by a business payment agent, said business payment agent being authorized to transmit said service invoice on behalf of a client of said primary service provider.

5. A method for invoice agent coupling comprising the steps of:
a) receiving a service invoice generated by a primary service provider;
b) authorizing payment of said service invoice;
c) transmitting said service invoice to a supply chain financing service provider; and
d) transmitting a services payment to said primary service provider.

6. The method of claim 5, further including the step of negotiating a payment agreement between said primary service provider and a client of said primary service provider prior to said step a).

7. The method of claim 5, wherein said step c) is performed in response to said step b).

8. The method of claim 7, further including the step of accessing a supply chain financing portal provided by said supply chain financing service provider prior to said step a).

9. The method of claim 5, further including the step of processing a request for an early payment authorization in response to said step c), wherein said step d) is performed prior to a maturity date.

10. The method of claim 5, further including the step of granting a business unit status to an audit and payment service provider to perform said steps b) through c) on behalf of a client of said primary service provider.

11. The method of claim 10, further including the step of processing a request for early payment authorization in response to said step c), wherein said step d) is performed prior to a predetermined maturity date.

12. The method of claim 5, further including the step of authorizing a business payment agent status to an audit and payment service provider wherein said audit and payment service provider performs said step c).

13. The method of claim 12, further including the step of processing a request for early payment authorization in response to said step c), wherein said step d) is performed prior to a predetermined maturity date.

14. The method of claim 13, wherein said step of processing a request for early payment authorization is performed by said primary service provider.

15. The method of claim 14, further including the step of negotiating a financing agreement between a financial institution and said primary service provider, wherein said services payment is provided by said financial institution.

16. The method of claim 15, wherein said financing agreement is guaranteed by a client of said primary service provider.

17. The method of claim 5, further including the step of auditing said service invoice prior to said step b).

18. The method of claim 17, wherein said step of auditing said service invoice further includes the steps of:
i) receiving a shipping record; and
ii) comparing said shipping record and said service invoice.

19. The method of claim 18, further comprising the step of confirming receipt of an article associated with said shipping record.

20. The method of claim 5, further including the step of comparing said service invoice to a predetermined business rule prior to said step c).
